(19) United States
(12) Patent Application Publication
(10) Pub. No.: US 2026/0088392 A1
(43) Pub. Date: Mar. 26, 2026

(54) BATTERY MODULE

(71) Applicant: SAMSUNG SDI CO., LTD., Yongin-si (KR)

(72) Inventor: Pil Yong MOON, Yongin-si (KR)

(21) Appl. No.: 19/341,769

(22) Filed: Sep. 26, 2025

(30) Foreign Application Priority Data
Sep. 26, 2024 (KR) 10-2024-0130979

(51) Int. Cl. H01M 10/6555; H01M 10/613; H01M 10/653; H01M 10/6556; H01M 50/209

(52) U.S. Cl. CPC H01M 10/6555; H01M 10/613; H01M 10/653; H01M 10/6556; H01M 50/209; H01M 2200/10

(57) ABSTRACT

The present disclosure relates to a battery module including a plurality of secondary batteries, a housing accommodating the plurality of secondary batteries, a flow path configured to apply a fire extinguishing agent into an internal space of the housing at or greater than a first predetermined temperature, and a cooling sheet positioned in at least one gap between the plurality of secondary batteries and configured to absorb the fire extinguishing agent.

### CROSS-REFERENCE TO RELATED APPLICATION

This application claims priority to and the benefit of Korean Patent Application No. 10-2024-0130979, filed on Sep. 26, 2024, in the Korean Intellectual Property Office, the entire disclosure of which is hereby incorporated by reference.

### BACKGROUND

### 1. Field

The present disclosure relates to a battery module including a cooling sheet.

### 2. Description of Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

As the demand for secondary batteries increases, secondary batteries are increasingly used in the form of modules including a plurality of secondary batteries.

This Background section is for the general understanding of the background of the present disclosure, and therefore, it may contain information that does not constitute related (or prior) art.

### SUMMARY

The present disclosure is directed to a battery module including a cooling sheet.

The present disclosure is directed to a battery module including a flow path for spraying a fire extinguishing agent.

The present disclosure is directed to a battery module including a cooling sheet capable of improving cooling efficiency while reducing the amount of a fire extinguishing agent.

Embodiments of the present disclosure provide a battery module including a plurality of secondary batteries, a housing configured to accommodate the plurality of secondary batteries, a flow path configured to spray a fire extinguishing agent into an internal space of the housing at a first temperature or higher, and a cooling sheet positioned in at least one of gaps between the plurality of secondary batteries and configured to absorb the fire extinguishing agent.

Embodiments of the present disclosure provide a battery module including a plurality of secondary batteries, a housing accommodating the plurality of secondary batteries, a flow path configured to apply a fire extinguishing agent into an internal space of the housing at or greater than a first predetermined temperature, and a cooling sheet positioned in at least one gap between the plurality of secondary batteries and configured to absorb the fire extinguishing agent.

In some embodiments, the fire extinguishing agent is configured to be absorbed through at least a portion of the cooling sheet and configured to be spread throughout an entirety of the cooling sheet.

In some embodiments, the cooling sheet includes an absorption layer including a hygroscopic material.

In some embodiments, the hygroscopic material includes a superabsorbent resin, a tissue paper, a moisture absorbent, an absorbent fiber, or combinations thereof.

In some embodiments, the absorption layer further includes a first insulating material mixed with the hygroscopic material.

In some embodiments, the absorption layer further includes a first insulating material having at least a portion of an outer surface coated with the hygroscopic material.

In some embodiments, the first insulating material includes aerogel, wet silica, dry silica, polyurethane, polystyrene, polyethylene, polyester, or a combination thereof.

In some embodiments, the cooling sheet further includes a support covering at least a portion of an outer side portion of the absorption layer, and wherein the support has at least a portion configured to be opened at or greater than a second predetermined temperature.

In some embodiments, the support is configured to be opened as at least a portion of the support melts at or greater than the second predetermined temperature.

In some embodiments, the support includes: an upper support covering an upper outer side portion of the absorption layer; a lower support covering a lower outer side portion of the absorption layer; or a side support covering a side outer side portion of the absorption layer.

In some embodiments, the lower support is configured to be opened as at least a portion of the lower support melts at or greater than the second predetermined temperature.

In some embodiments, the second predetermined temperature is equal to or greater than about 150° C. and less than or equal to about 700° C.

In some embodiments, a softening temperature of the support is equal to or greater than about 100° C.

In some embodiments, a flame resistance grade of the support is equal to or greater than V0.

In some embodiments, the support further includes a fixing portion configured to fix the cooling sheet to the secondary battery.

In some embodiments, the cooling sheet further includes a support insulation layer disposed on at least one surface of the absorption layer and includes a second insulating material.

In some embodiments, the second insulating material includes mica, sericite, talc, diatomaceous earth, bentonite, silicon, feldspar, kaolin, polyimide, polyethylene terephthalate, or combinations thereof.

In some embodiments, the flow path includes a thermo-sensitive material configured to melt at or greater than the first predetermined temperature.

In some embodiments, the fire extinguishing agent includes a liquid fire extinguishing agent or a gaseous fire extinguishing agent.

In some embodiments, the first predetermined temperature is equal to or greater than about 100° C. and less than or equal to about 150° C.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings:

FIG. 1 is a perspective view of a battery module according to embodiments of the present disclosure;

FIG. 2 is a perspective view of a secondary battery according to embodiments of the present disclosure;

FIG. 3 is a cross-sectional view of the secondary battery according to embodiments of the present disclosure;

FIG. 4 is a perspective view of an interior of a housing according to embodiments of the present disclosure;

FIG. 5 is a perspective view of an interior of a battery module where a fire extinguishing agent is sprayed according to embodiments of the present disclosure;

FIG. 6 is a perspective view of a cooling sheet according to embodiments of the present disclosure;

FIG. 7 schematically describes an operating process of a cooling sheet according to embodiments of the present disclosure;

FIG. 8 is a perspective view of a cooling sheet according to embodiments of the present disclosure;

FIG. 9 is a perspective view of the cooling sheet according to embodiments of the present disclosure;

FIG. 10 schematically describes an operating process of a cooling sheet according to embodiments of the present disclosure;

FIG. 11 is a perspective view of a cooling sheet according to embodiments of the present disclosure;

FIG. 12 is a side view of the cooling sheet according to embodiments of the present disclosure;

FIG. 13 is a perspective view of the cooling sheet according to embodiments of the present disclosure; and

FIG. 14 schematically describes an operating process of a cooling sheet according to embodiments of the present disclosure.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

Therefore, embodiments described in the specification and configurations shown in the drawings are merely some of the most preferred embodiments of the present disclosure, and, not intended to fully describe the technical aspects of the present disclosure, so it should be understood that a variety of other equivalents and modifications could be made thereto at the time of filing the application. In addition, when used herein, the words “comprise” and “include,” and/or “comprising” and “including” specify the presence of stated features, numbers, steps, operations, members, elements and/or groups thereof, but do not preclude the presence or addition of one or more other features, numbers, operations, members, elements and/or groups thereof. In addition, when describing embodiments of the present disclosure, the phrase “may perform” or “may be” may include “one or more embodiments of the present disclosure.”

Furthermore, to help the understanding of the present disclosure, the accompanying drawings are not drawn to actual scale and the dimension of some elements may be exaggerated. In addition, the same reference numerals may be assigned to the same components in different embodiments.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

The statement that two objects of comparison are “the same” means “substantially the same.” Therefore, “substantially the same” may include deviations that are considered to be low in the art, for example, deviations of 5% or less. In addition, uniformity of a parameter over a given region may mean uniformity from an average perspective.

Although “first,” “second,” etc., are used to describe various components, the components are of course not limited by the terms. The terms are only used to distinguish one component from another, and unless otherwise stated, the first component may of course also be the second component.

Throughout the specification, unless otherwise specifically stated, each element may be singular or plural.

That any component is disposed “at an upper portion (or lower portion)” of a component or “on (or under)” a component may mean not only that the any component is disposed in contact with an upper surface (or lower surface) of the component, but also that another component may be interposed between the component and any component disposed on (or under) the component.

Further, when one component is described as being “connected,” “coupled,” or “linked” to another component, the component may be directly connected or able to be linked to the other component, but it is also to be understood that an additional component may be “interposed” between the two components, or the two components may be “connected,” “coupled,” or “linked” through an additional component. In addition, when a part is referred to as being “electrically coupled” to another part, this includes not only cases where they are directly coupled, but also cases where they are connected with another element interposed therebetween.

Throughout the specification, “A and/or B,” means A, B, or A and B, unless otherwise specified. That is, “and/or” includes all or any combination of the listed items. “C to D” means C or more and D or less, unless otherwise specifically stated.

When a phrase such as “at least one of A, B, and C,” “at least one of A, B, or C,” “at least one selected from the group A, B, and C,” or “at least one selected from A, B, and C” is used to specify a list of elements A, B, and C, the phrase may refer to any suitable combination.

The term “use” may be considered synonymous with the term “utilize. ” As used in the present specification, the terms “substantially,” “about,” and similar terms are used as terms of approximation rather than as terms of degree, and are intended to take into account the inherent variation in measured or calculated values that will be recognized by those of ordinary skill in the art.

Although the terms first, second, third, etc. may be used in the present specification to describe various elements, components, regions, layers and/or sections, the elements, components, regions, layers and/or sections should not be limited by the terms. The terms are used to distinguish one element, component, region, layer, or section from another element, component, region, layer, or section. Accordingly, a first element, component, region, layer or section discussed below may be termed a second element, component, region, layer or section without departing from the teachings of exemplary embodiments.

For ease of description, spatial relative terms such as “beneath,” “below,” “lower,” “above,” “upper,” and the like may be used in the present specification to describe the relationship of one element or feature to another element(s) or feature(s) as illustrated in the drawings. Spatially relative positions will be understood to encompass different orientations of a device in use or operation in addition to the orientation depicted in the figures. For example, when a device in a drawing is overturned, an element described as “below” or “beneath” another element is understood to be “on” or “above” the other element. Therefore, the term “below” may encompass both upward and downward directions.

Terms used in the present specification are for the purpose of describing embodiments of the present disclosure and are not intended to limit the present disclosure.

In the present disclosure, an x-axis represents a lateral direction of a battery module 1000. In the present disclosure, a y-axis represents a longitudinal direction of the battery module 1000. The y-axis is perpendicular to the x-axis. In the present disclosure, a z-axis represents a vertical direction of the battery module 1000. The z-axis is perpendicular to each of the x-axis and y-axis.

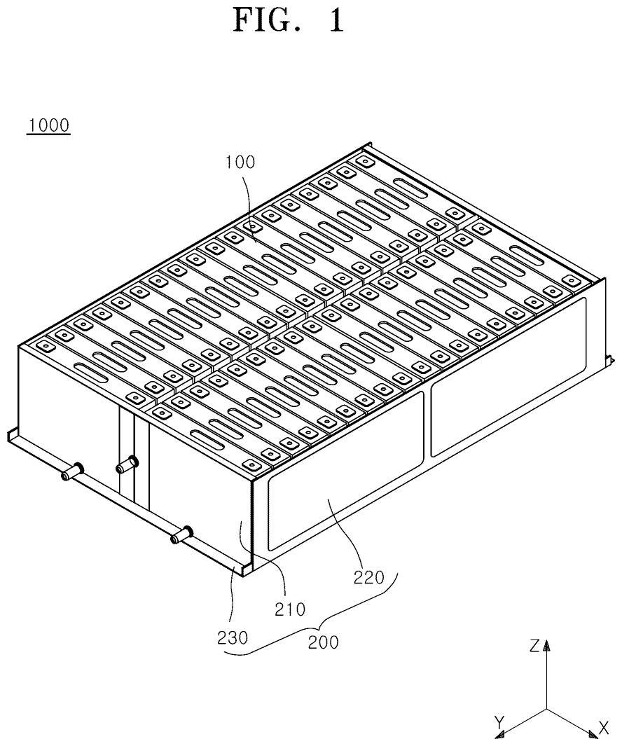

FIG. 1 is a perspective view of a battery module. The battery module 1000 includes a plurality of secondary batteries 100 and a housing 200 that accommodates the plurality of secondary batteries 100.

The battery module 1000 includes the plurality of secondary batteries 100. The secondary battery 100 may function as a unit structure that stores and supplies electricity in the battery module 1000.

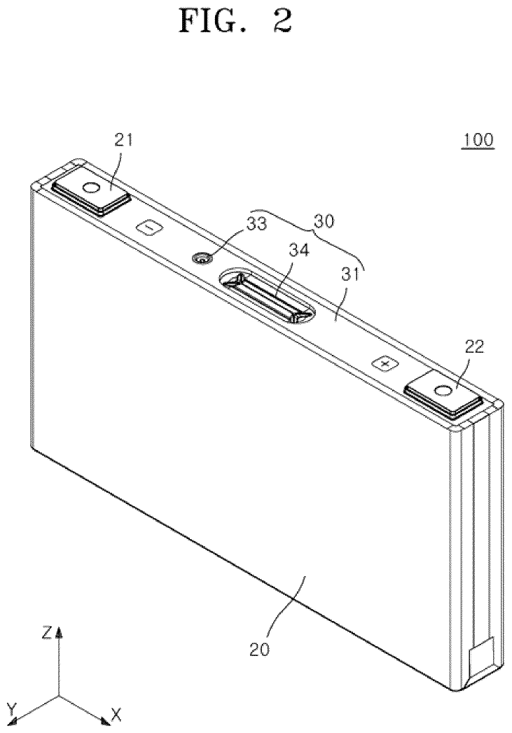

The secondary battery 100 includes a battery cell in which, for example, a case 20 (see FIG. 2) of the secondary battery 100 is formed in a prismatic geometry. However, the geometry of the secondary battery 100 applicable to the battery module 1000 is not limited thereto. For example, the secondary battery 100 may be formed in various geometries such as a pouch geometry, a cylinder geometry, and a coin geometry. Hereinafter, a case having a prismatic geometry is described as an example embodiment.

The plurality of secondary batteries 100 are disposed inside the housing 200. The housing 200 forms a rough exterior of the battery module 1000. The housing 200 may support the plurality of secondary batteries 100 as a whole.

The housing 200 accomodates the plurality of secondary batteries 100 in its internal space.

The plurality of secondary batteries 100 are arranged in a first direction in the internal space of the housing 200.

The first direction may be the same direction as a longitudinal direction (y-axis) of the battery module 1000. For example, the secondary battery 100 includes a first side surface and a second side surface that face each other. The first side surface and the second side surface include wide surfaces of the side surfaces of the secondary battery 100. For example, the plurality of secondary batteries 100 may be arranged such that the first side surface of one secondary battery faces a second side surface of an adjacent battery cell. The first direction is a direction from the first side surface toward the second side surface.

The housing 200 may include an end plate 210, a side plate 220 and a lower plate 230, together defining the internal space for accommodating the secondary battery 100.

The end plate 210 corresponds to a portion of the side surfaces of the housing 200. For example, the end plate 210 corresponds to a side surface positioned in the first direction among the side surfaces of the housing 200. The end plate 210 may face the wide surface of the side surfaces of the secondary battery 100. For example, a pair of end plates 210 opposite to each other may correspond to both side surfaces of the housing 200.

The secondary battery 100 may experience swelling as charging and discharging are repeated. The swelling of the secondary battery 100 may be more noticeable on a relatively wider side. The end plate 210 may restrain the secondary battery 100 from swelling even when the swelling occurs in the secondary battery 100 and/or support the exterior of the housing 200.

The side plate 220 corresponds to another portion of the side surfaces of the housing 200. For example, the side plate 220 corresponds to a side surface positioned in a second direction among the side surfaces of the housing 200. The second direction may be the same direction as a lateral direction (an x axis) of the battery module 1000. The second direction may be a direction perpendicular to the first direction. For example, a pair of side plate 220 opposite to each other may correspond to the other two side surfaces of the housing 200. One side of the side plate 220 and the other side of the side plate 220 may be connected to the pair of end plates 210.

The lower plate 230 corresponds to a lower surface of the housing 200. The lower plate 230 may, for example, support the plurality of secondary batteries 100 at the bottom. The lower plate 230 may be connected to the end plate 210 and the side plate 220.

In this manner, the internal space of the housing 200 is defined by the end plate 210, the side plate 220, and the lower plate 230.

FIG. 2 is a perspective view of a secondary battery.

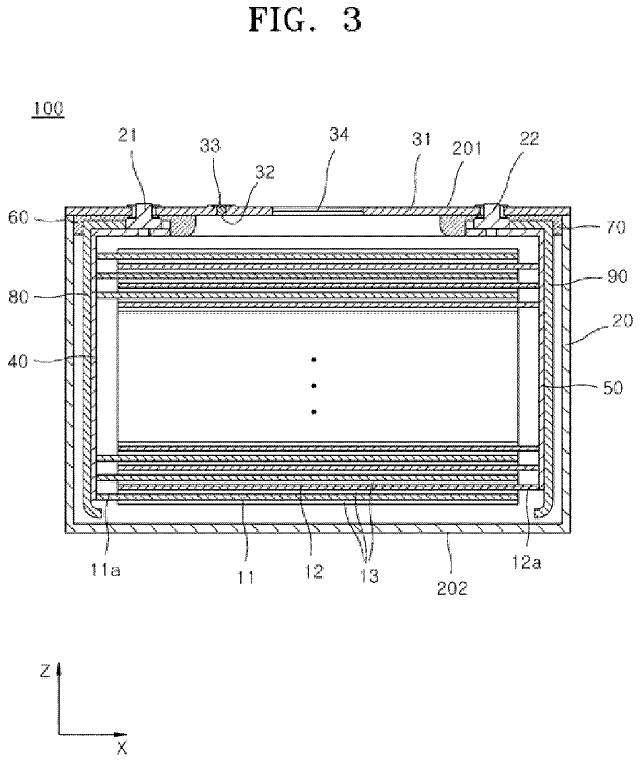

FIG. 3 is a cross-sectional view of the secondary battery.

Referring to FIGS. 2 and 3, the secondary battery 100 may include at least one electrode assembly formed by winding a positive electrode 11 and a negative electrode 12 with a separator 13, which is an insulator, interposed therebetween, a case 20, and a cap assembly 30 coupled to an opening of the case 20.

The secondary battery 100 is described as a prismatic lithium ion secondary battery as an example embodiment. However, the present disclosure is not limited thereto, and the secondary battery 100 may be a lithium polymer battery or a cylindrical battery.

The positive electrode 11 and the negative electrode 12 may include a coated portion where a current collector, including a thin metal foil, is coated with an active material. The positive electrode 11 and the negative electrode 12 may include uncoated portions 11a and 12a not coated with the active material.

The positive electrode 11 and the negative electrode 12 may be wound after interposing the separator 13, which is an insulator, therebetween. However, the present disclosure is not limited thereto, and the electrode assembly may have a structure in which positive electrodes and negative electrodes composed of a plurality of sheets are alternately stacked with a separator interposed therebetween.

The case 20 may define the overall exterior of the secondary battery 100, and may include a conductive metal such as aluminum, an aluminum alloy, or nickel-plated steel. The case 20 may provide a space accomodating the electrode assembly.

The cap assembly 30 may include a cap plate 31 that covers the opening of the case 20. The case 20 and the cap plate 31 may include a conductive material. A terminal 21,22 electrically connected to the positive electrode 11 or the negative electrode 12 may protrude externally through the cap plate 31.

A pair of terminals 21,22 may protrude externally through the cap plate 31. The pair of terminals 21,22 may be connected to the positive electrode 11 and the negative electrode 12, and may function as a positive electrode terminal and a negative electrode terminal, respectively, of the secondary battery 100.

The terminals 21,22 may be electrically connected to current collectors including first and second current collectors 40 and 50 (referred to as “positive and negative current collectors”) that are bonded by welding to a positive uncoated region 11a or a negative uncoated region 12a. For example, a pair of terminals 21,22 may be coupled to the positive and negative current collectors 40 and 50 by welding. However, the present disclosure is not limited thereto, and the terminals 21 and 22 and the positive and negative current collectors 40 and 50 may be integrally coupled. An outer peripheral surface of an upper pillar of the terminal 21,22 may be threaded and fixed to the cap plate 31 with a nut.

However, the present disclosure is not limited thereto, and the terminals 21,22 may have a rivet structure, or may be coupled to the cap plate 31 by welding.

The cap plate 31 may include a thin plate and coupled to the opening of the case 20. In the cap plate 31 may have an electrolyte inlet 32, where a sealing stopper 33 is installed, and may have a vent 34 installed.

The vent 34 may be opened and closed in conjunction with changes in internal pressure of the case 20. The vent 34 may remain closed to seal the case 20 during normal operation of the electrode assembly. The vent 34 may be open when the internal pressure of the case 20 rises above a predetermined level due to overcharging or a fire, and discharge emissions such as a flame and gas to the exterior of the case 20.

An insulating member may be installed between the electrode assembly and the cap plate 31. The insulating member may include first and second lower insulating members 60 and 70, and each of the first and second lower insulating members 60 and 70 may be installed between the electrode assembly and the cap plate 31.

One end of a separating member facing one side surface of the electrode assembly may be installed between the insulating member and the terminal 21,22.

The separating member may include a first separating member 80 and a second separating member 90.

Respective one ends of the first and second separating members 80 and 90 facing side surfaces of the electrode assembly may be installed between the first lower insulating member 60 and the positive electrode terminal 21 and between the second lower insulating member 70 and the negative electrode terminal 22, respectively.

As a result, the terminals 21 and 22 coupled to the positive and negative current collectors 40 and 50, respectively, by welding may be coupled to one end of each of the first and second lower insulating members 60 and 70, respectively, and one end of each of the first and second separating members 80 and 90, respectively.

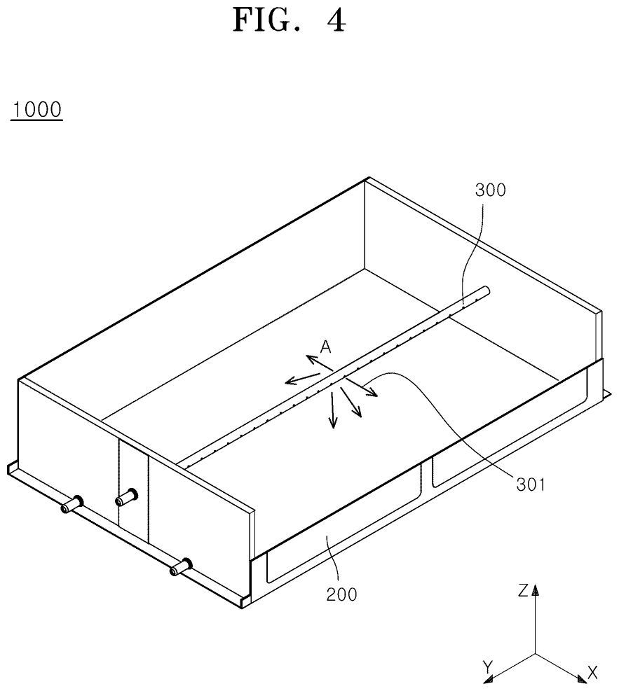

FIG. 4 is a perspective view of an interior of a housing.

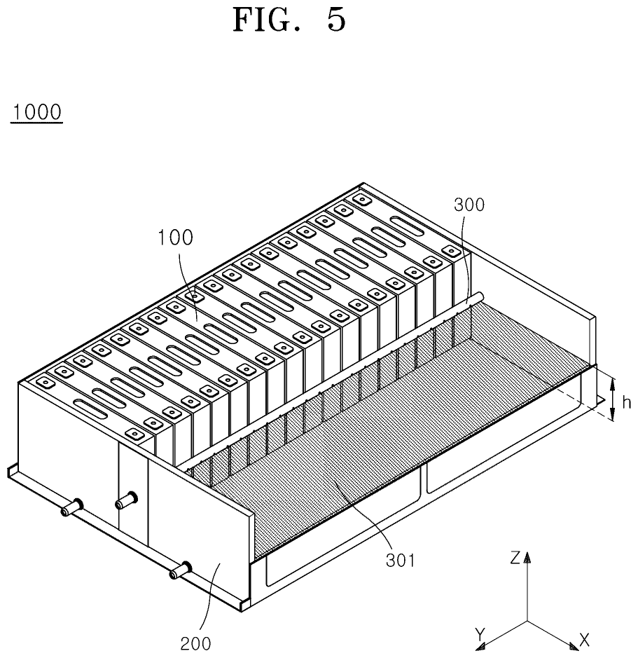

FIG. 5 is a perspective view of an interior of a battery module where a fire extinguishing agent is sprayed.

Referring to FIGS. 4 and 5, the battery module 1000 includes a flow path 300.

The flow path 300 is disposed in an internal space of the housing 200. For example, the flow path 300 is disposed in the internal space of the housing 200 in the first direction. The first direction includes, for example, a longitudinal direction (y-axis) of the battery module 1000.

For example, the flow path 300 may have a pipe geometry connecting the end plates 210 formed on both sides. For example, the flow path 300 may have a pipe geometry connecting the side plates 220 formed on both sides.

For example, a plurality of secondary batteries 100 may form a battery structure arranged in the first direction.

The battery module 1000 may include one or more battery structures. For example, the plurality of battery structures may be arranged in a lateral direction (x-axis) of the battery module 1000.

The present specification provides an example embodiment where two battery structures are arranged in two rows. The battery module 1000 may have two columns in the lateral direction (x-axis) and a plurality of rows in the longitudinal direction (y-axis).

For example, the plurality of secondary batteries 100 include a battery structure in which a plurality of battery cells are arranged in the first direction. For example, the battery structure includes a first battery structure and a secondary battery structure arranged in two rows in the lateral direction of the battery module 1000.

The flow path 300 may be provided between the first battery structure and the secondary battery structure when viewed from above. The flow path 300 may be provided on an upper portion of the secondary battery 100 or may be provided on a side portion of the secondary battery 100.

Although not shown in FIGS. 4 and 5, the flow path 300 may be connected to a fire extinguishing agent storage tank positioned external to the housing 200 through a flow path exposed to the exterior of the housing 200. The flow path 300 may be supplied with a fire extinguishing agent 301 from the fire extinguishing agent storage tank.

The flow path 300 may include a thermo-sensitive material having a melting point set at a first predetermined temperature.

The first predetermined temperature may be, for example, an ignition temperature of the secondary battery 100. The first predetermined temperature is, for example, about 100° C. to about 150° C. For example, the first predetermined temperature is about 110° C. to about 150° C. For example, the first predetermined temperature is about 100° C. to about 140° C. For example, the first predetermined temperature is about 110° C. to about 140° C. For example, the first predetermined temperature is about 110° C. to about 130° C.

If the first predetermined temperature is less than about 100° C., the flow path 300 may melt during charging and discharging the secondary battery 100. If the first temperature exceeds about 150° C., a fire may occur from the secondary battery 100 and the flow path 300 may eventually melt. As fire suppression is delayed, the cooling effect of the battery module 1000 is reduced.

For example, a thermo-sensitive material includes Polyamide 12 (PA12)l. For example, the thermo-sensitive material may include high-density polyethylene (HDPE), linear low-density polyethylene (LLDPE), low-density polyethylene (LDPE), acrylonitrile butadiene styrene (ABS), or alphamethylstyrene acrylonitrile (AMSAN). For example, the flow path 300 may have a tube including PA12.

As the flow path 300 melts, the flow path 300 releases the fire extinguishing agent 301 present in the flow path 300. Becuase the flow path 300 is positioned in the internal space of the housing 200, the fire extinguishing agent 301 may be released to the internal space of the housing 200, for example, as shown as A in FIG. 4.

However, the geometry and/or disposition of the flow path 300 is not limited thereto. For example, the flow path 300 may be installed on the exterior of the housing 200 and inject the fire extinguishing agent 301 into the interior of the housing 200. The flow path 300 may spray the fire extinguishing agent 301 into the interior of the housing 200 when the internal temperature of the housing 200 reaches or exceeds a predetermined temperature. The flow path 300 may be applied to the battery module 1000 in any geometry and/or disposition capable of spraying the fire extinguishing agent 301 into the internal space of the housing 200.

The fire extinguishing agent 301 may include, for example, a liquid fire extinguishing agent. For example, the fire extinguishing agent may include sulfuric acid, potassium carbonate, sodium bicarbonate, aluminum sulfate, water, halons, a halogen compound, or a combination thereof.

The fire extinguishing agent 301 may include, for example, a gaseous fire extinguishing agent and/or a solid fire extinguishing agent. For example, the fire extinguishing agent may include novec1230, nitrogen, solid aerosol, or a combination thereof.

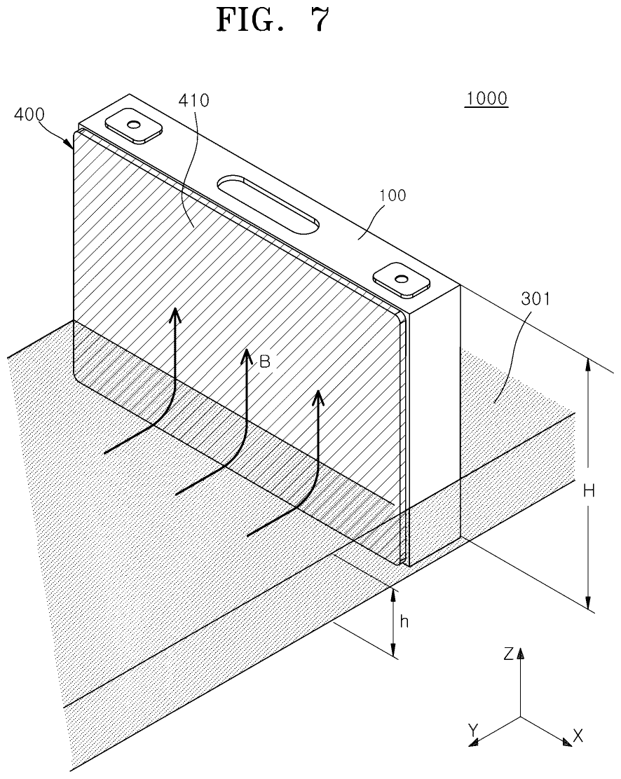

The fire extinguishing agent 301 may fill up to a predetermined height h in the internal space of the housing 200. The predetermined height h has a value less than a height of the battery module 1000. The predetermined height h has a value less than a height H (see FIG. 7) of the secondary battery 100. For example, the predetermined height h may have a value that is ⅓ of the height H of the secondary battery.

The flow path 300 is designed to spray an amount of fire extinguishing agent 301 that fills only a portion of the battery module 1000. This is because the amount of fire extinguishing agent 301, that may be loaded onto the battery module 1000, may be limited. For example, the fire extinguishing agent 301 may fill only a lower portion of the battery module 1000. Cooling of an upper portion of the secondary battery 100 may not be achieved or may be delayed compared to cooling of the lower portion.

Accordingly, the battery module 1000 includes a plurality of secondary batteries 100, the housing 200 that accommodates the plurality of secondary batteries 100, the flow path 300 that sprays the fire extinguishing agent 301 into the internal space of the housing 200 when the temperature meets or exceeds a first predetermined temperature, and a cooling sheet 400 that is positioned in at least one of gaps between the plurality of secondary batteries 100 and absorbs the fire extinguishing agent 301.

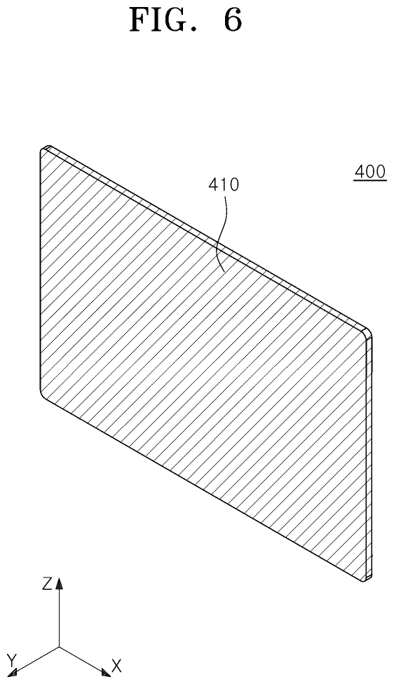

FIG. 6 is a perspective view of a cooling sheet.

A cooling sheet 400 absorbs a fire extinguishing agent 301. For example, the cooling sheet 400 allows the fire extinguishing agent 301 to be absorbed through at least a portion thereof and spread throughout the entire cooling sheet.

As described in FIG. 5, the cooling sheet 400 may be positioned in at least one of gaps between secondary batteries 100. One side and/or both sides of the cooling sheet 400 faces a long side surface of the secondary battery 100. One side and/or both sides of the cooling sheet 400 are in surface contact with the long side surface of the secondary battery 100.

Accordingly, the cooling sheet 400 allows the absorbed fire extinguishing agent 301 to face or come into contact with the long side surface of the secondary battery 100. The cooling sheet 400 allows the fire extinguishing agent 301 to function over the entire surface or most of the area of a long side surface of an adjacent secondary battery 100.

As described in FIGS. 4 and 5, the fire extinguishing agent 301 may come into contact only with a portion of the secondary battery 100. The cooling sheet 400 allows the fire extinguishing agent 301 to face the upper portion of the secondary battery 100. The cooling sheet 400 allows the fire extinguishing agent 301 to operate from the bottom to the top of the secondary battery 100. The cooling sheet 400 may improve the cooling efficiency for the secondary battery 100 and/or a battery module 1000 even with a relatively small amount of fire extinguishing agent 301.

The cooling sheet 400 includes an absorption layer 410.

The absorption layer 410 may have a sheet geometry. The absorption layer 410 may have a thin plate geometry.

The absorption layer 410 may be formed corresponding to the geometry of a case 20 of the secondary battery 100. For example, if the secondary battery 100 is a prismatic secondary battery, the absorption layer 410 may be formed as a quadrangle-type sheet or plate. For example, if the secondary battery 100 corresponds to a cylindrical or coin-type secondary battery, the absorption layer 410 may have a holder geometry into which the cylindrical battery may be inserted.

The geometry of the absorption layer 410 is not limited thereto. The present disclosure provides an example embodiment in which the absorption layer includes a quadrangle-type sheet.

The absorption layer 410 may absorb the fire extinguishing agent 301. For example, the absorption layer 410 may absorb the fire extinguishing agent 301 sprayed from the flow path 300. For example, if the fire extinguishing agent 301 is a liquid fire extinguishing agent, the absorption layer 410 absorbs the fire extinguishing agent 301 through its portion or the entire body. When the absorption layer 410 absorbs the fire extinguishing agent 301, the absorption layer 410 allows the fire extinguishing agent 301 to spread throughout the entire absorption layer 410.

The absorption layer 410 includes a hygroscopic material. As used herein, the hygroscopic material refers to a material that absorbs the fire extinguishing agent 301, which may be liquid or gaseous.

The hygroscopic material may include, for example, a super absorbent polymer (SAP), a tissue paper, a moisture absorbent, a fiber, or a combination thereof. However, the hygroscopic material is not limited thereto, and includes all types of materials capable of absorbing liquid and/or gaseous fire extinguishing agent 301.

The fiber may include a fiber-type inorganic material, a fiber-type metallic material, an absorbent fiber, or a glass fiber.

For example, the fiber-type inorganic material may include glass wool, rock wool, a glass fiber, rock wool, a gypsum fiber, a silica fiber, an alumina fiber, a zirconia fiber, a carbon fiber, or combinations thereof.

For example, the fiber-type metal material may include gold, silver, iron, steel, aluminum, beryllium, tungsten, molybdenum, stainless steel, or combinations thereof, that has a fiber geometry.

For example, the absorbent fiber may include an absorbent resin including a starch-based material, a cellulosic material, a synthetic polymer-based material, or combinations thereof.

For example, the absorption layer 410 may include a first insulating material mixed with the hygroscopic material. For example, the absorption layer 410 includes a mixture and/or a compound formed by adding the hygroscopic material to the first insulating material. For example, the absorption layer 410 includes a mixture and/or a compound formed by adding the first insulating material to the hygroscopic material. For example, the absorption layer 410 may have a weight ratio between the hygroscopic material and the first insulating material being 1:99 to 100:0. For example, the absorption layer 410 may be formed by adding an aerogel, corresponding to the first insulating material, into a porous nonwoven fabric structure, corresponding to the hygroscopic material.

For example, the absorption layer 410 may include a first insulating material having at least a portion of an outer surface coated with the hygroscopic material. For example, the absorption layer 410 may be formed by coating one or both surfaces of the first insulating material with the hygroscopic material. For example, the absorption layer 410 may include a first layer including the first insulating material and a second layer including the hygroscopic material provided on one or both surfaces of the first insulating material.

The first insulating material allows the absorption layer 410 to be insulating. For example, the absorption layer 410 allows the cooling sheet 400 to suppress heat diffusion from one secondary battery 100 to another secondary battery 100 adjacent to the secondary battery 100 through the first insulating material.

For example, the first insulating material may include aerogel, wet silica, dry silica, polyurethane, polystyrene, polyethylene, polyester, or a combination thereof.

For example, the absorption layer 410 may cover about 30% to about 110% of an area of the long side surface of the secondary battery 100 (e.g., including the first side surface and the second side surface described in FIGS. 4 and 5). If the area of the absorption layer 410 is less than about 30% of the area of the long side surface of the secondary battery 100, the cooling performance of the fire extinguishing agent 301 may not be satisfactory even when the absorption layer 410 absorbs the fire extinguishing agent 301. If the area of the absorption layer 410 exceeds 110% of the area of the long side surface of the secondary battery 100, the capacity of the battery module 1000 may be reduced by the absorption layer 410.

For example, the absorption layer 410 may have an area corresponding to the long side surface of the secondary battery 100. The absorption layer 410 may maximize cooling and/or flame spread blocking.

The cooling sheet 400 may effectively prevent thermal runaway by absorbing the fire extinguishing agent 301.

FIG. 7 schematically describes an operating process of a cooling sheet.

As described in FIG. 6, a cooling sheet 400 may absorb a fire extinguishing agent 301. The cooling sheet 400 may include an absorption layer 410 capable of absorbing the fire extinguishing agent 301.

As described in FIGS. 1 to 6, the battery module 1000 includes a plurality of secondary batteries 100, a flow path 300 for spraying the fire extinguishing agent 301, and the cooling sheet 400 positioned in all or at least one of the gaps between the secondary batteries 100. The cooling sheet 400 may face and/or be in surface contact with the long side surface of the secondary battery 100.

FIG. 7 shows the fire extinguishing agent 301 being sprayed from the flow path 300 into an internal space of a housing 200.

As illustrated in FIG. 7, for example, the fire extinguishing agent 301 may be sprayed so that a lower portion of the secondary battery 100 is submerged. The fire extinguishing agent 301 may have a height h in the internal space of the housing 200.

The fire extinguishing agent 301 may be sprayed so that the lower portion of the cooling sheet 400 is submerged together with the secondary battery 100. Accordingly, the lower portion of the cooling sheet 400 may be wet or submerged by the fire extinguishing agent 301.

The cooling sheet 400 may absorb the fire extinguishing agent 301 through the absorption layer 410. The fire extinguishing agent 301 penetrates into the cooling sheet 400. The absorption layer 410 allows the fire extinguishing agent 301 to spread inside the cooling sheet 400. The fire extinguishing agent 301 may spread from the bottom to the top of the cooling sheet 400 in the B direction. For example, the fire extinguishing agent 301 may reach the height H via being absorbed by the cooling sheet 400.

H represents the height of the cooling sheet 400. When the height of the cooling sheet 400 and the height of the secondary battery 100 are the same, H may represent the height of the secondary battery 100. The cooling sheet 400 absorbs and spreads the fire extinguishing agent 301 that has been wet only up to the height of h, so that the fire extinguishing agent 301 may reach to height H.

Even though a relatively small amount of the fire extinguishing agent 301 is sprayed into the internal space of the housing 200, cooling may be efficiently provided to the entire secondary battery 100. The battery module 1000 may improve cooling efficiency and effectively reduce thermal runaway.

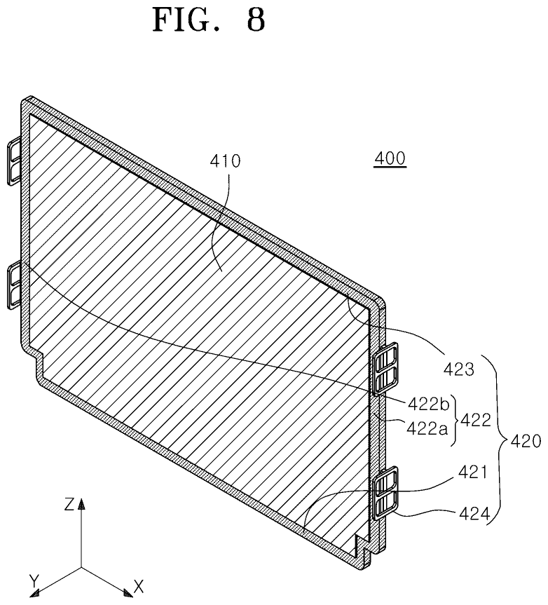

FIG. 8 is a perspective view of a cooling sheet.

A cooling sheet 400 absorbs a fire extinguishing agent 301. For example, the cooling sheet 400 allows the fire extinguishing agent 301 absorbed through at least a portion thereof to spread throughout the entire cooling sheet. As described in FIGS. 6 and 7, the cooling sheet 400 may include an absorption layer 410.

The absorption layer 410 may be provided inside a battery module 1000 sandwiched between a plurality of secondary batteries 100. The absorption layer 410 may be provided inside the battery module 1000 by being attached to the long side surface of at least one of the plurality of secondary batteries 100.

The cooling sheet 400 may further include a support 420.

The support 420 allows the cooling sheet 400 to be fixedly positioned relative to an adjacent secondary battery 100. The support 420 maintains an appropriate gap between the secondary batteries 100. When the gap between the secondary batteries 100 is not maintained, a short circuit may occur between the secondary batteries 100 and/or thermal runaway may rapidly progress between the secondary batteries 100 when an initial thermal runaway occurs in one secondary battery 100.

The support 420 may protect the absorption layer 410. The support 420 allows the absorption layer 410 to efficiently absorb the fire extinguishing agent 301 when the fire extinguishing agent 301 is sprayed.

The support 420 may cover at least a portion of an outer side portion of the absorption layer 410. The support 420 covers the outer side portion of the absorption layer 410 to allow the absorption layer 410 to be positioned between the secondary batteries 100 while maintaining its exterior.

The support 420 may provide a path through which the absorption layer 410 absorbs the fire extinguishing agent 301. To this end, the support 420 may be at least partially open at or greater than a second predetermined temperature to expose the absorption layer 410.

For example, the support 420 may include at least one of a lower support 421, a side support 422, and an upper support 423.

The upper support 423 covers at least a portion of an upper outer side portion of the absorption layer 410. The upper portion of the absorption layer 410 corresponds to the upper portion of the secondary battery 100. For example, when the fire extinguishing agent 301 is sprayed into the internal space of the housing 200 and the secondary battery 100 and/or the cooling sheet 400 are impregnated, the upper portion of the absorption layer 410 may not be impregnated. The upper support 423 may support at least a portion of the upper outer side portion of the absorption layer 410.

The lower support 421 covers at least a portion of the lower outer side portion of the absorption layer 410. The lower portion of the absorption layer 410 corresponds to the lower portion of the secondary battery 100. For example, when the fire extinguishing agent 301 is sprayed into the internal space of the housing 200 and the secondary battery 100 and/or the cooling sheet 400 are impregnated, the lower portion of the absorption layer 410 may be impregnated. The lower support 421 may support at least a portion of the lower outer side portion of the absorption layer 410. The lower support 421 may be provided at a position opposite to the upper support 423.

The side support 422 is formed to cover at least a portion of the side outer side portion of the absorption layer 410. The side portion of the absorption layer 410 corresponds to the side portion of the secondary battery 100. For example, when the fire extinguishing agent 301 is sprayed into the internal space of the housing 200 and the secondary battery 100 and/or the cooling sheet 400 are impregnated, at least a portion of the side portion of the absorption layer 410 may be impregnated. The side support 422 may support at least a portion of the side outer side portion of the absorption layer 410. The side support 422 may connect the lower support 421 and the upper support 423. The side support 422 may include a pair of side supports 422a and 422b. When the side support 422 includes the pair of side supports 422a and 422b, the pair of side supports 422a and 422b are formed to face each other. The pair of side supports 422a and 422b may each connect one side of the lower support 421 to one side of the upper support 423 or connect the other side of the lower support 421 to the other side of the upper support 423.

For example, the support 420 may include only one of the lower support 421, the side support 422, and the upper support 423. For example, the support 420 may include the lower support 421 and the side support 422. For example, the support 420 may include the lower support 421 and the upper support 423. For example, the support 420 may include the side support 422 and the upper support 423. For example, the support 420 may include the lower support 421, the side support 422, and the upper support 423.

The support 420 may have a thickness equal to or similar to the thickness of the absorption layer 410. For example, the support 420 may have a thickness of about 80% to about 150% of the thickness of the absorption layer 410. For example, the support 420 may have a thickness of about 80% to about 145% of the thickness of the absorption layer 410. For example, the support 420 may have a thickness of about 85% to about 140% of the thickness of the absorption layer 410. For example, the support 420 may have a thickness of about 90% to about 135% of the thickness of the absorption layer 410. For example, the support 420 may have a thickness of about 90% to about 130% of the thickness of the absorption layer 410. For example, the support 420 may have a thickness of about 95% to about 125% of the thickness of the absorption layer 410. If the support 420 has a thickness less than about 80% of the thickness of the absorption layer 410, the support 420 may have a weak force supporting the geometry of the absorption layer 410. If the support 420 has a thickness exceeding about 150% of the thickness of the absorption layer 410, the support 420 may reduce the capacity of the battery module 1000. The support 420 supports the absorption layer 410 by covering at least a portion of the outer side portion of the absorption layer 410.

When the fire extinguishing agent 301 is sprayed into the housing 200, the support 420 may obstruct the path through which the absorption layer 410 absorbs the fire extinguishing agent 301. When the fire extinguishing agent 301 is sprayed into the housing 200, as at least a portion of the support 420 is opened, and the support 420 may allow the outer side portion of the absorption layer 410 to be exposed.

For example, the support 420 may have an open bottom so that the absorption layer 410 may absorb the fire extinguishing agent 301 impregnated in the lower portion of the secondary battery 100 and/or the cooling sheet 400. For example, the lower support 421 of the support 420 may be opened. For example, the lower support 421 and/or side support 422 of the support 420 may be opened. For example, the upper support 423 of the support 420 may be opened.

The support 420 allows the absorption layer 410 to absorb the fire extinguishing agent 301 not only through the surface but also through the outer side portion. Accordingly, the cooling efficiency of the cooling sheet 400 may be improved.

For example, the support 420 may include a fixing portion 424 that allows the cooling sheet 400 to be fixed to the secondary battery 100.

The fixing portion 424 may extend, for example, from the support 420 in a direction perpendicular to a plane of the cooling sheet 400 (e.g., in a y-axis direction). FIG. 8 illustrates an example in which the fixing portion 424 is formed by extending from the side support 422 in a normal direction of the cooling sheet. However, the fixing portion 424 may extend from the lower support 421 and/or the upper support 423. The fixing portion 424 may extend from all of the lower support 421, the side support 422, and the upper support 423.

The fixing portion 424 may extend from the support 420 in a linear geometry, a planar geometry, or a combination thereof,. The fixing portion 424 may have, for example, a fastening member or a hook capable of being coupled to the secondary battery 100 and extending from the support 420.

The fixing portion 424 allows the cooling sheet 400 to be fixed to the side surface of the secondary battery 100. The fixing portion 424 may align adjacent secondary batteries 100 or prevent the adjacent secondary batteries 100 from moving.

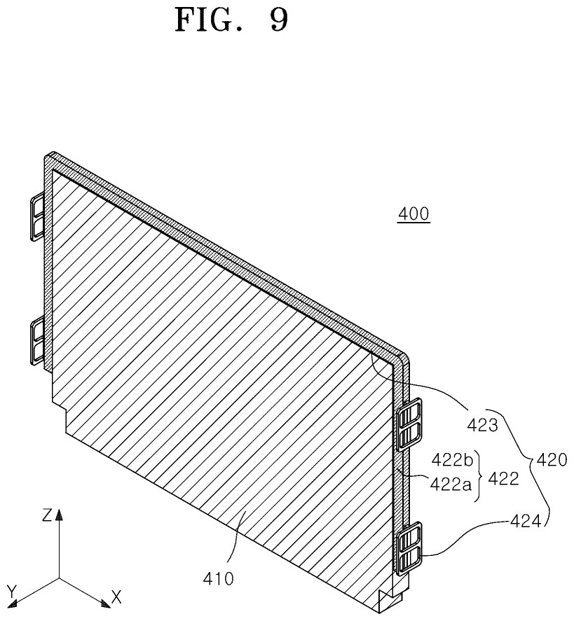

FIG. 9 is a perspective view of the cooling sheet.

FIG. 9 shows the cooling sheet 400 described in FIG. 8 being opened.

As described in FIG. 8, the cooling sheet 400 may include the absorption layer 410 and the support 420. The support 420 may be opened as at least a portion thereof melts at the second temperature or higher.

For example, the support 420 may be opened as at least a portion thereof melts at or greater than the second predetermined temperature. For example, at least a portion of the lower support 421 of the support 420 may melt. For example, the lower support 421 may be opened as at least a portion thereof melts at or greater than the second predetermined temperature. For example, at least a portion of the side support 422 of the support 420 may melt. For example, the side support 422 may be opened as at least a portion thereof melts at or greater than the second predetermined temperature. For example, at least a portion of the upper support 423 of the support 420 may melt. For example, the upper support 423 may be opened as at least a portion thereof melts at or greater than the second predetermined temperature.

FIG. 9 illustrates a portion of the outer side portion of the absorption layer 410 being opened as a portion of the lower support 421 and the side support 422 melts.

The second predetermined temperature may be equal to or greater than the first predetermined temperature. If the second predetermined temperature is less than the first predetermined temperature, a fire may not occur and/or the support 420 may melt due to heat generated during charging and discharging the secondary battery 100. The support 420 may not support the cooling sheet 400, or the support 420 may interfere with charging and discharging of the secondary battery 100. For example, the second predetermined temperature may be equal to or greater than about 150° C. and less than or equal to about 700° C. The support 420 may be opened after the fire extinguishing agent 301 is sprayed.

The support 420 may have a softening temperature of equal to or greater than about 100° C. The softening temperature is less than the second predetermined temperature. The support 420 is designed to be opened when the temperature of the battery module 1000 rises. The support 420 may maintain its geometry without melting if the temperature of the secondary battery 100 does not rise further. The support 420 may allow the outer side portion of the absorption layer 410 to be opened without maintaining its geometry if the temperature of the secondary battery 100 rises greater than the softening temperature and reaches the second predetermined temperature.

A flame resistance grade of the support 420 may be V0 or higher. The support 420 may contribute to preventing heat transfer during heating or when temperature rises.

The support 420 may include, for example, polycarbonate (PC), polyethylene terephthalate (PET), HDPE, polypropylene (PP), LLDPE, polypropylene homopolymer (PP-HOMO), polypropylene copolymer (PP-Copolymer), or AMSAN. However, the material is not limited thereto, and the support 420 may include any material that melts at or greater than the second predetermined temperature and has a softening temperature of equal to or greater than about 100° C.

The support 420 may be formed, for example, through injection molding, but the manufacturing process of the support 420 is not limited thereto.

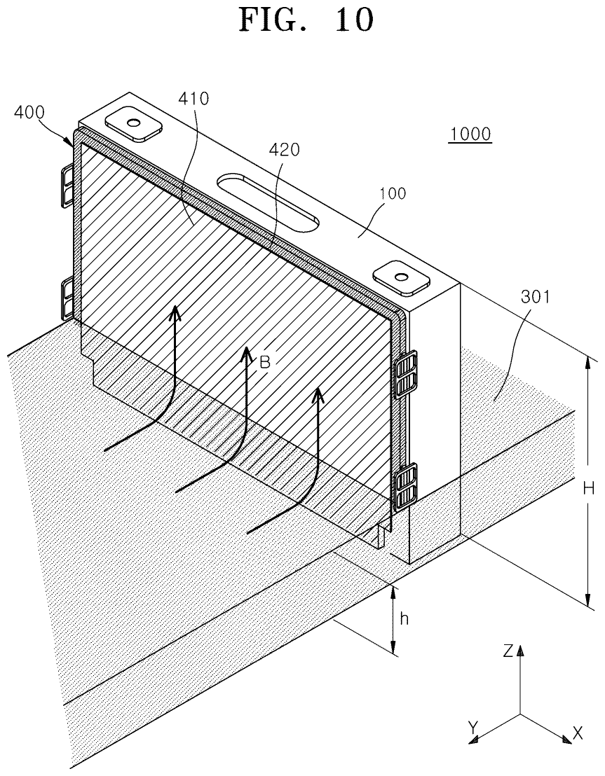

FIG. 10 schematically describes an operating process of a cooling sheet.

As described in FIGS. 6 to 9, a cooling sheet 400 may absorb a fire extinguishing agent 301. The cooling sheet 400 may include an absorption layer 410 capable of absorbing the fire extinguishing agent 301 and a support 420.

FIG. 10 shows the fire extinguishing agent 301 being sprayed into an internal space of a housing 200 from a flow path 300.

As illustrated in FIG. 10, for example, the fire extinguishing agent 301 may be sprayed so that a lower portion of the secondary battery 100 is impregnated. The fire extinguishing agent 301 may have a height h in the internal space of the housing 200.

The fire extinguishing agent 301 may be sprayed so that the lower portion of the cooling sheet 400 is submerged together with the secondary battery 100. The lower portion of the cooling sheet 400 may be wet or submerged by the fire extinguishing agent 301.

The support 420 may be at least partially opened. For example, the support 420 may be opened as at least a portion of the support 420 melts. For example, the support 420 may be opened as a portion of the lower portion and/or the side portion thereof melts, as illustrated in FIG. 10. Accordingly, the outer side portion of the absorption layer 410 may be exposed.

The cooling sheet 400 may absorb the fire extinguishing agent 301 through the absorption layer 410. For example, the absorption layer 410 may absorb the fire extinguishing agent 301 through at least a portion of the outer edge portion and/or at least a portion of the surface.

The fire extinguishing agent 301 penetrates into the cooling sheet 400. The absorption layer 410 allows the fire extinguishing agent 301 to spread throughout the cooling sheet 400. The fire extinguishing agent 301 may spread from the bottom to the top of the cooling sheet 400 in the B direction. For example, the fire extinguishing agent 301 may reach height H via being absorbed by the cooling sheet 400.

H represents the height of the cooling sheet 400. When the height of the cooling sheet 400 and the height of the secondary battery 100 are the same, H may represent the height of the secondary battery 100. The cooling sheet 400 absorbs and spreads the fire extinguishing agent 301 that has been wetted only to a height of a portion of the secondary battery 100 (e.g., the height of h), so that the fire extinguishing agent 301 may reach to height H.

Even though a relatively small amount of the fire extinguishing agent 301 is sprayed into the internal space of the housing 200, cooling may be efficiently provided to the entire secondary battery 100. The battery module 1000 may improve cooling efficiency and effectively reduce thermal runaway of the battery module 1000.

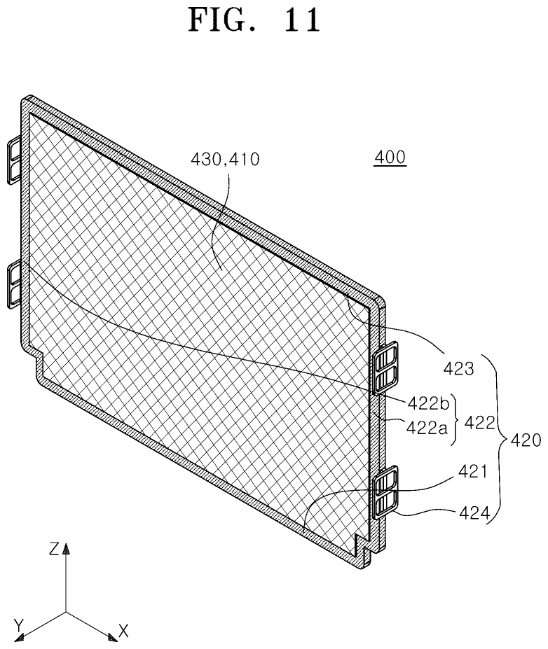

FIG. 11 is a perspective view of a cooling sheet.

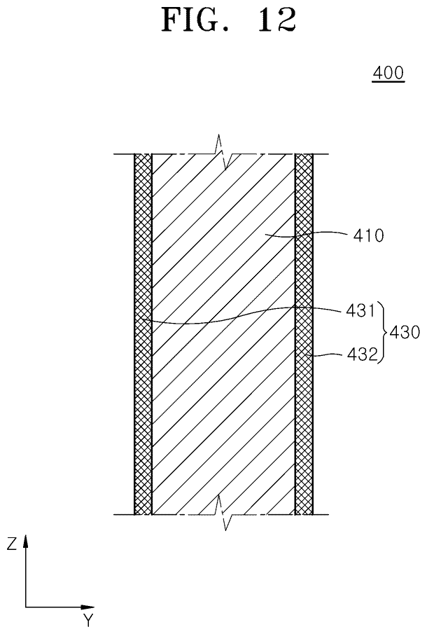

FIG. 12 is a side view of the cooling sheet.

A cooling sheet 400 absorbs a fire extinguishing agent 301. For example, the cooling sheet 400 allows the fire extinguishing agent 301 to be absorbed through at least a portion thereof to spread throughout the entire cooling sheet.

As described in FIGS. 6 and 7, the cooling sheet 400 may include an absorption layer 410. As described in FIGS. 6 to 9, the cooling sheet 400 may include the absorption layer 410 and a support 420.

The support 420 is provided on an outer side portion of the absorption layer 410 to prevent the outer side portion of the absorption layer 410 from being exposed and/or to maintain the distance between the secondary batteries 100.

The cooling sheet 400 may include a support insulation layer 430.

As illustrated in FIG. 12, the support insulation layer 430 is disposed on at least one surface of the absorption layer 410. For example, the support insulation layer 430 may be disposed on one surface of the absorption layer 410, or may be disposed on both surfaces. If the support insulation layer 430 is disposed on both surfaces of the absorption layer 410, a pair of support insulation layers 431 and 432 may be provided to face each other with the absorption layer 410 interposed therebetween.

For example, the support insulation layer 430 may have a geometry identical to or similar to that of the absorption layer 410. For example, if the absorption layer 410 is a quadrangle-type sheet, the support insulation layer 430 may be a quadrangle-type sheet. Each of the support insulation layers 430 may have a thickness of about 5% to about 30% of the thickness of the absorption layer 410.

The support insulation layer 430 is a substrate of the cooling sheet 400. For example, the support insulation layer 430 allows the cooling sheet 400 to maintain the geometry of the sheet. The support insulation layer 430 may block heat diffusion.

Due to the characteristics of the cooling sheet 400, a component included in the cooling sheet 400 should not be deformed by heat and/or should not damage a surrounding secondary battery 100 by heat. Accordingly, the cooling sheet 400 has insulation and/or heat resistance while maintaining its geometry.

For example, the support insulation layer 430 includes a second insulating material. The second insulating material may include an insulating material having insulation and/or heat resistance properties while maintaining its geometry.

For example, the second insulating material may include mica, sericite, talc, diatomaceous earth, bentonite, silicon, feldspar, kaolin, polyimide, polyethylene terephthalate, or combinations thereof.

However, the second insulating material is not limited thereto, and the second insulating material includes any material that may have insulation and support the geometry of the absorption layer 410.

The cooling sheet 400 may improve insulation properties and effectively prevent thermal runaway.

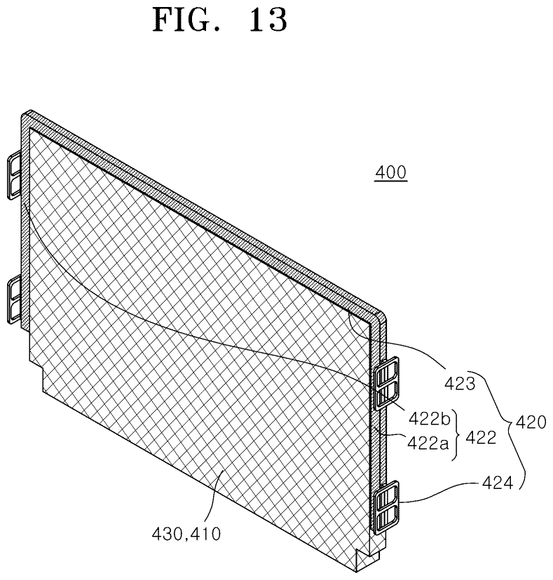

FIG. 13 is a perspective view of the cooling sheet.

FIG. 13 shows at least a portion of the cooling sheet 400 described in FIGS. 11 and 12 being opened.

As described in FIGS. 11 and 12, the cooling sheet 400 may include the absorption layer 410, the support 420, and the support insulation layer 430. The support 420 may be opened as at least a portion thereof melts at or greater than the second predetermined temperature. For example, the support 420 may be opened as at least a portion thereof melts at or greater than the second predetermined temperature. For example, at least a portion of the lower support 421 of the support 420 may melt. For example, the lower support 421 may be opened as at least a portion thereof melts at or greater than the second predetermined temperature. For example, at least a portion of the side support 422 of the support 420 may melt. For example, the side support 422 may be opened as at least a portion thereof melts at or greater than the second predetermined temperature. For example, at least a portion of the upper support 423 of the support 420 may melt. For example, the upper support 423 may be opened as at least a portion thereof melts at or greater than the second predetermined temperature.

FIG. 9 illustrates an example in which a portion of the outer side portion of the absorption layer 410 is opened as a portion of the lower support 421 and the side support 422 melts.

The support 420 may provide the path through which the absorption layer 410 may absorb the fire extinguishing agent 301 through the outer side portion as at least a portion of the support 420 is opened at or greater than the second predetermined temperature.

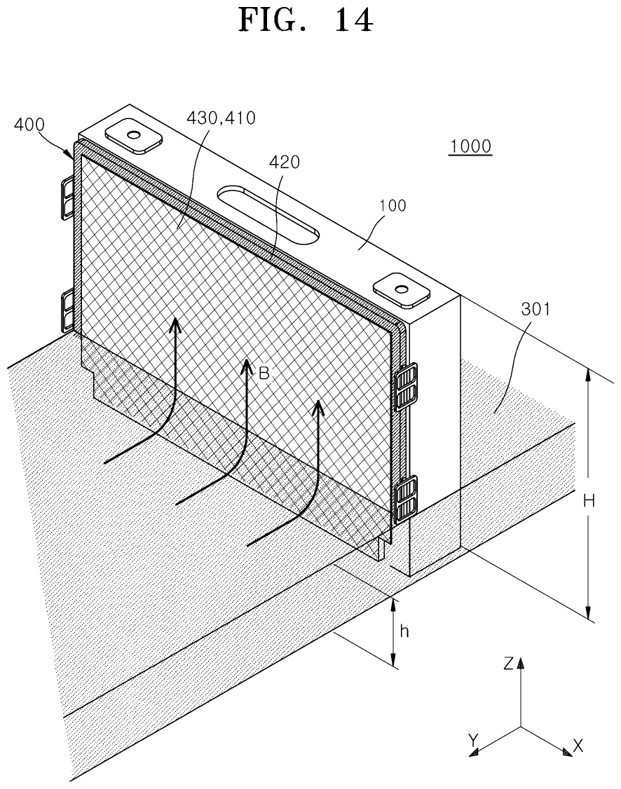

FIG. 14 schematically describes an operation process of a cooling sheet.

As described in FIGS. 6 to 13, a cooling sheet 400 may absorb a fire extinguishing agent 301.

The cooling sheet 400 may include an absorption layer 410 capable of absorbing the fire extinguishing agent 301 and a support insulation layer 430. The cooling sheet 400 may include the absorption layer 410, a support 420, and the support insulation layer 430.

FIG. 14 shows the fire extinguishing agent 301 being sprayed into an internal space of a housing 200 from a flow path 300.

As illustrated in FIG. 14, for example, the fire extinguishing agent 301 may be sprayed so that a lower portion of the secondary battery 100 is impregnated. The fire extinguishing agent 301 may fill up to a height h in the internal space of the housing 200.

The fire extinguishing agent 301 may be sprayed so that the lower portion of the cooling sheet 400 is submerged together with the secondary battery 100. The lower portion of the cooling sheet 400 may be wet or submerged by the fire extinguishing agent 301.

The support 420 may be at least partially opened. For example, the support 420 may be opened as at least a portion of the support 420 melts. For example, the support 420 may be opened as a portion of the lower portion and/or the side portion thereof melts, as illustrated in FIG. 14. Accordingly, the outer side portion of the absorption layer 410 may be exposed.

The cooling sheet 400 may absorb the fire extinguishing agent 301 through the absorption layer 410. For example, the absorption layer 410 may absorb the fire extinguishing agent 301 through at least a portion of the outer side portion.

The fire extinguishing agent 301 penetrates into the cooling sheet 400. The absorption layer 410 allows the fire extinguishing agent 301 to spread throughout the cooling sheet 400. The fire extinguishing agent 301 may spread from the bottom to the top of the cooling sheet 400 in the B direction. For example, the fire extinguishing agent 301 may reach the height H via being absorbed by the cooling sheet 400.

H represents the height of the cooling sheet 400. When the height of the cooling sheet 400 and the height of the secondary battery 100 are the same, H may represent the height of the secondary battery 100. The cooling sheet 400 absorbs and spreads the fire extinguishing agent 301 that has been wetted only to a height of a portion of the secondary battery 100 (e.g., the height of h), so that the fire extinguishing agent 301 may reach to height H.

Even though a relatively small amount of the fire extinguishing agent 301 is sprayed into the internal space of the housing 200, cooling may be efficiently provided to the entire secondary battery 100. The battery module 1000 may improve cooling efficiency and effectively reduce thermal runaway of the battery module 1000.

The battery module 1000 may efficiently cool the battery module 1000 using a relatively small amount of fire extinguishing agent 301 even when the temperature of the secondary battery 100 and/or the battery module 1000 rises. The battery module 1000 may reduce the possibility of thermal runaway through the cooling sheet 400.

Although not illustrated, the battery module 1000 may include both the cooling sheet 400 and the insulating sheet. For example, the battery module 1000 may include cooling sheets 400 and insulating sheets alternately positioned between the secondary batteries 100. The battery module 1000 may include cooling sheets 400 and insulating sheets randomly distributed between a plurality of secondary batteries 100.

The insulating sheet may be formed as one layer including a first insulating material, a second insulating material, and/or a combination thereof. The insulating sheet may include a first layer including the first insulating material and a second layer including the second insulating material. The insulating sheet may be formed by stacking the first layer and the second layer. The insulating sheet may be formed by alternately stacking one or more first layers and one or more second layers.

Embodiments of the present disclosure provide a battery module having improved cooling efficiency.

For example, the cooling speed can be improved.

For example, the amount of a fire extinguishing agent can be reduced.

However, the effects that can be obtained through the present disclosure are not limited to the effects described, and other technical effects that are not mentioned will be clearly understood by those skilled in the art from the description of the disclosure.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A battery module comprising:
a plurality of secondary batteries;
a housing accommodating the plurality of secondary batteries;
a flow path configured to apply a fire extinguishing agent into an internal space of the housing at or greater than a first predetermined temperature; and
a cooling sheet positioned in at least one gap between the plurality of secondary batteries and configured to absorb the fire extinguishing agent.

2. The battery module of claim 1, wherein the fire extinguishing agent is configured to be absorbed through at least a portion of the cooling sheet and configured to be spread throughout an entirety of the cooling sheet.

3. The battery module of claim 1, wherein the cooling sheet comprises an absorption layer comprising a hygroscopic material.

4. The battery module of claim 3, wherein the hygroscopic material comprises a superabsorbent resin, a tissue paper, a moisture absorbent, an absorbent fiber, or combinations thereof.

5. The battery module of claim 3, wherein the absorption layer further comprises a first insulating material mixed with the hygroscopic material.

6. The battery module of claim 3, wherein the absorption layer further comprises a first insulating material having at least a portion of an outer surface coated with the hygroscopic material.

7. The battery module of claim 5, wherein the first insulating material comprises aerogel, wet silica, dry silica, polyurethane, polystyrene, polyethylene, polyester, or a combination thereof.

8. The battery module of claim 3, wherein the cooling sheet further comprises a support covering at least a portion of an outer side portion of the absorption layer, and wherein the support has at least a portion configured to be opened at or greater than a second predetermined temperature.

9. The battery module of claim 8, wherein the support is configured to be opened as at least a portion of the support melts at or greater than the second predetermined temperature.

10. The battery module of claim 8, wherein the support comprises:
an upper support covering an upper outer side portion of the absorption layer;
a lower support covering a lower outer side portion of the absorption layer; or
a side support covering a side outer side portion of the absorption layer.

11. The battery module of claim 10, wherein the lower support is configured to be opened as at least a portion of the lower support melts at or greater than the second predetermined temperature.

12. The battery module of claim 8, wherein the second predetermined temperature is equal to or greater than about 150° C. and less than or equal to about 700° C.

13. The battery module of claim 8, wherein a softening temperature of the support is equal to or greater than about 100° C.

14. The battery module of claim 8, wherein a flame resistance grade of the support is equal to or greater than V0.

15. The battery module of claim 8, wherein the support further comprises a fixing portion configured to fix the cooling sheet to the secondary battery.

16. The battery module of claim 2, wherein the cooling sheet further comprises a support insulation layer disposed on at least one surface of the absorption layer and comprises a second insulating material.

17. The battery module of claim 16, wherein the second insulating material comprises mica, sericite, talc, diatomaceous earth, bentonite, silicon, feldspar, kaolin, polyimide, polyethylene terephthalate, or combinations thereof.

18. The battery module of claim 1, wherein the flow path comprises a thermo-sensitive material configured to melt at or greater than the first predetermined temperature.

19. The battery module of claim 1, wherein the fire extinguishing agent comprises a liquid fire extinguishing agent or a gaseous fire extinguishing agent.

20. The battery module of claim 1, wherein the first predetermined temperature is equal to or greater than about 100° C. and less than or equal to about 150° C.
